(19) United States
(12) Patent Application Publication
(10) Pub. No.: US 2006/0202860 A1
(43) Pub. Date: Sep. 14, 2006

(54) FIBER OPTIC TRACK CIRCUIT

(75) Inventors: John C. Tsai, Saratoga, CA (US); David W. Wang, Saratoga, CA (US); Lynn Reiter, Rohnert Park, CA (US)

Correspondence Address: INTELLECTUAL PROPERTY LAW OFFICES, 1901 S. BASCOM AVENUE, SUITE 660, CAMPBELL, CA, 95008, US

(73) Assignee: FIBERA, INC., Santa Clara, CA (US)

(21) Appl. No.: 11/308,196

(22) Filed: Mar. 10, 2006

Related U.S. Application Data
(60) Provisional application No. 60/594,094, filed on Mar. 10, 2005.

(51) Int. Cl. G08C 19/12

(52) U.S. Cl. 340/870.28

(57) ABSTRACT

A fiber optic track circuit including a light source, a fiber Bragg grating (FBG) unit, and a receiver all connected by optical fiber. The light source provides a light via the optical fiber to the FBG unit. The FBG unit is mountable on a portion of a railway system directly effected by the weight of a passing train, and it receives the light beam and provides a reflected beam to the receiver. The receiver then provides a receiver signal based on the reflected beam. And a processor then determines, based on pre-set criteria and the receiver signal, whether to communicate and what to communicate as a track circuit signal to an external device.

### CROSS-REFERENCE TO RELATED APPLICATIONS

This application claims the benefit of U.S. Provisional Application No. 60/594,094, filed 10 Mar. 2005 and hereby incorporated by reference in its entirety.

### TECHNICAL FIELD

The present invention relates generally to railway safety, and more particularly to such in railroad track circuits.

### BACKGROUND ART

The track circuit is an important tool in railway operations. With the advancement of high-speed trains and heavy freight trains, the function of the track circuit is increasingly important to safe and efficient railway operations.

Current track circuits use electrical wiring to connect the two tracks in a railway section to a voltage supplied by a battery. The tracks in the section are insolated from the other sections of tracks by a set of isolation pads to minimize current leakage. A resistor, an open/close switch, one Green signal light, and one Red signal light are typically also connected to the circuit formed in this manner. The wheels and axles of trains passing through the railway section of the track circuit then act as a shunt (short), thus operating the track circuit.

FIG. 1 (prior art) is a simplified basic circuit diagram for a conventional direct current (DC) track circuit. A battery is connected across the tracks or rails at one end in the isolated section, close to the insulated joints. Typically, positive energy is applied to the south rail “S” and negative energy to the north rail “N.” The relay is connected across the rails at the other end of the isolated section, with one lead of the relay coils connecting to the rail “S” and the other to the rail “N”. With the battery and relay connected in this manner, current has a complete path in which to flow, as indicated here by arrowed lines.

Accordingly, the track circuit is designed principally as a series circuit. When a train enters the isolated section of rails its wheels and axles place a shunt (short) on the track circuit. This creates a low resistance current path from one rail to the other, changing the series circuit to a parallel circuit with intentional current paths through the relay coil as well as through the train wheels and axles.

FIG. 2 (prior art) is a circuit diagram for a more complex conventional track circuit, one showing the relay contacts of a DC track circuit controlling a lighting circuit. Here one train axel and set of wheels is also shown and arrowed lines indicate the high current path through the shunt they create. Most of the current in the parallel circuit here flows through the low resistance shunt path rather than through the higher resistance relay coil path. This reduces the current in the relay sufficiently enough to cause its armature to drop out, thereby opening or closing contacts as desired.

In FIG. 2, the front (top shown) contact of the relay is part of a signal control circuit to operate a Green light signal and the back (bottom shown) contact operates a Red light signal. When a train enters the isolated rails section, the current is shunted in the track circuit and the relay de-energizes. The relay heel contact then makes with the back contact to light the Red light signal. Conversely, when the last pair of wheels of the train move off of the track circuit, the current again flows in an un-shunted manner through the track circuit, re-energizing the relay coil and causing the front contact to close and light the Green light signal.

The above discussion has covered theoretical track circuit operation. In practice, however, the effects of operational and environmental dynamics need to be taken into account to understand actual track circuit operation.

As can be seen in FIG. 2, when a train occupies a track circuit, it places a short circuit on the battery. In order to limit the amount of current drawn from the battery during this time a resistor is placed in series with the battery output to prevent the battery from becoming exhausted. A variable resistor is used in order to set the desired amount of discharge current during the period the track circuit is occupied. This resistor is called the “battery-limiting resistor.”

The seemingly straightforward matter of adjusting a track circuit for operation is, unfortunately, complicated by environmental factors. When good railroad ties are supported in good crushed stone the complete isolated rails section should be dry and the resistance to current flow from one rail to the other rail should be very high. This condition is known as “maximum ballast resistance” and is ideal for good track circuit operation. Conversely, when the ballast present is wet or contains substances such as salt or minerals that conduct electricity easily, current can flow or leak from one rail to the other rail. This condition is termed “minimum ballast resistance” and it produces a ballast leakage current that is high. The total current drain from the battery during normal conditions therefore adds up to current through each ballast resistance and through the relay coils.

When the ballast resistance decreases significantly, the theoretical series circuit of the track circuit effectively, undesirably becomes a parallel circuit. When this happens, the relay can be robbed of enough current that it become de-energized, or fails to pick up again after it has been de-energized by the passage of a train.

Track circuits thus can be a very dynamic and unpredictable, and a mechanism to attempt to deal with this is also shown in FIGS. 1-2. Because the ballast resistance varies between a wet day (minimum ballast resistance) and a dry day (maximum ballast resistance) the flow of current from the battery will also vary. Accordingly, when the battery-limiting resistor is adjusted as specified, higher current will flow through the relay coil on a dry day due to maximum ballast resistance. If this current is too high, however, the relay will be hard to shunt. To overcome this a variable resistor is also inserted in series with the relay coil at the relay end of the track circuit, to adjust the amount of current flowing in the relay coils.

It follows from the above that the conventional track circuit has many drawbacks. It has very poor durability—the failure rate is very high and it has to be repaired or replaced at frequent intervals. It also is not accurate. It produces many false alarms, which cause accidents or unnecessarily stop trains and significantly increase railway operational costs. It also quite often fails to produce a signal when a train does pass by, which seriously affects railroad safety. It can not detect the direction of train movement. And it cannot provide information about the weight of an approaching train, which is often important to local railway, police, and emergency personnel.

### DISCLOSURE OF INVENTION

Accordingly, it is an object of the present invention to provide an improved railroad track circuit.

Briefly, one preferred embodiment of the present invention is a fiber optic track circuit having a light source, a fiber Bragg grating (FBG) unit, and a receiver all connected by optical fiber. The FBG unit is mountable on a portion of a railway system directly effected by the weight of a passing train. The light source provides a light beam via the optical fiber to the FBG unit, which receives the light beam and provides a reflected beam via the optical fiber to the receiver. The receiver then provides a receiver signal based on the reflected beam. And a processor then determines, based on pre-set criteria and the receiver signal, whether to communicate and what to communicate as a track circuit signal to an external device.

Briefly, another preferred embodiment of the present invention is a process for determining information about a train passing through a railway system. A light beam is conveyed to a fiber Bragg grating (FBG) unit mounted on a portion of the railway system that is directly effected by the weight of the passing train. A reflected beam is then produces at the FBG unit based on the light beam. This reflected beam is then conveyed to a receiver, that produces a receiver signal based on the reflected beam. Finally, the receiver signal is processed based on pre-set criteria to obtain the information.

And briefly, another preferred embodiment of the present invention is a system for determining information about a train passing through a railway system. A Bragg means for reflecting a particular light wavelength based on the Bragg effect is provided, wherein the Bragg means is mountable on a portion of the railway system that is directly effected by the weight of the passing train. A producing means for producing a receiver signal based on the particular light wavelength then operates, and means for processing the receiver signal based on pre-set criteria to obtain the information then operates as well. To facilitate this, means for conveying a light beam to the Bragg means, for conveying the particular light wavelength to the producing means, and for conveying the receiver signal to the means for processing is employed.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1 (prior art) is a simplified basic circuit diagram for a conventional direct current (DC) track circuit.

FIG. 2 (prior art) is a circuit diagram for a more complex conventional track circuit.

FIG. 3 is a simplified schematic of a fiber optic track circuit in accord with the present invention.

FIGS. 4a-b are simplified schematics depicting the structure and operation of a fiber Bragg grating (FBG) unit that can be used in the fiber optic track circuit, wherein FIG. 4a shows the FBG unit before a force is exerted and FIG. 4b shows it after the force is exerted.

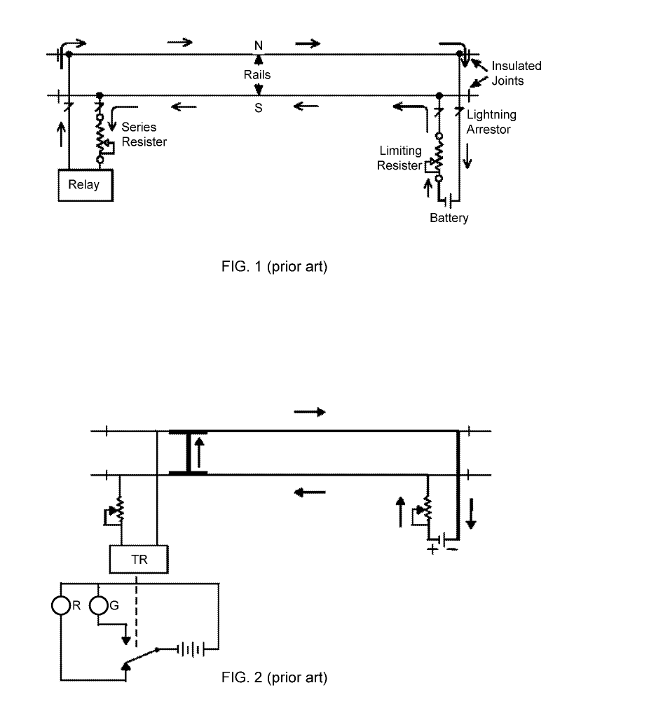

In the various figures of the drawings, like references are used to denote like or similar elements or steps.

### BEST MODE FOR CARRYING OUT THE INVENTION

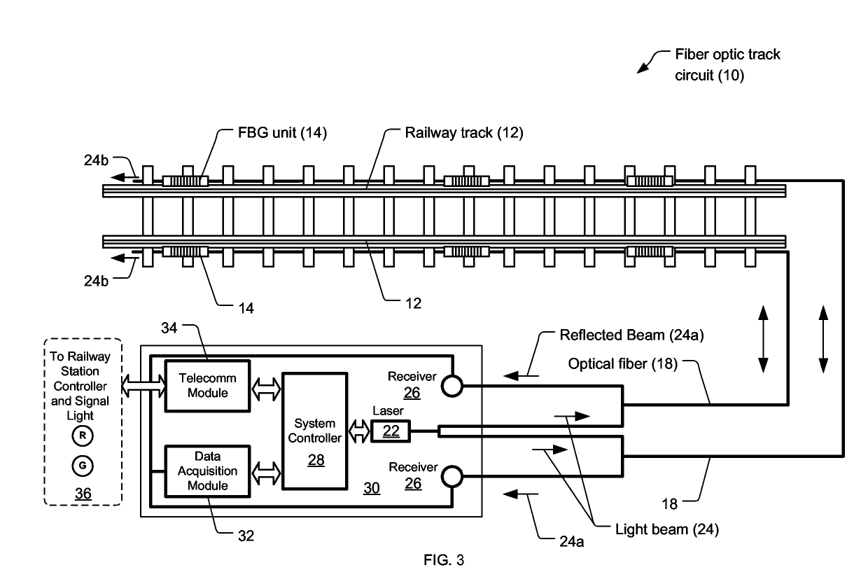

A preferred embodiment of the present invention is fiber optic track circuit. As illustrated in the various drawings herein, and particularly in the view of FIG. 3, preferred embodiments of the invention are depicted by the general reference character 10.

FIG. 3 is a simplified schematic of a fiber optic track circuit 10 in accord with the present invention. As with conventional track circuits, the fiber optic track circuit 10 is used on railway tracks 12. Unlike conventional track circuits, however, the tracks 12 where the fiber optic track circuit 10 is used do not have to be electrically insulated from other track sections and the amount of ballast resistance between the tracks 12 is totally irrelevant. Furthermore, the physical strength and robustness of the overall track assembly, and thus its safety, are benefited here by not requiring special track sections or joints between them.

Installation of the fiber optic track circuit 10 on just one track 12 is adequate, but FIG. 3 depicts a redundant installation on the second track 12 as well, for back-up purposes. At least one fiber Bragg grating unit (FBG unit 14) is attached to the web of the railway track 12 (or sleeper or other substantial structure that will nonetheless be stressed by the weight of a passing train). Attachment can be done by welding, bolting, gluing, or any other suitable fastening method. FIG. 3 shows three FBG units 14 installed on each of the two tracks 12 at three different locations. Using three FBG units 14 on a track 12 provides additional back-up redundancy. More usefully, however, this also permits determining the direction, speed acceleration, etc. of a train that is traveling, by noting the order in which the FBG units 14 are activated and the times between activations, etc.

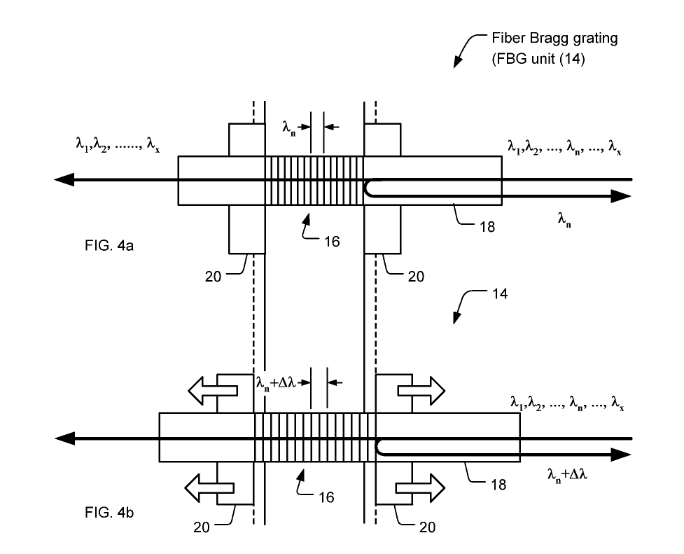

Turning briefly also to FIGS. 4a-b, these are simplified schematics depicting the structure and operation of a FBG unit 14 that can be used in the fiber optic track circuit 10, wherein FIG. 4a shows the FBG unit 14 before a force is exerted and FIG. 4b shows it after the force is exerted.

This FBG unit 14 includes a FBG zone 16 that is optically connected to or integral with optical fiber 18. The FBG unit 14 also includes mounting blocks 20 that hold the optical fiber 18 at opposite ends of the FBG zone 16. It is these mounting blocks 20 that are physically attached to the web of a railway track 12.

The FBG zone 16 is made to respond highly to a particular light wavelength and to be insensitive to other light wavelengths. A light source 22 (e.g., tunable laser, light emitting diode (LED), amplified spontaneous emission (ASE), or other broadband source) is provided (FIG. 3), and provides a light beam 24 via the optical fiber 18 to the FBG zone 16.

As shown in FIGS. 4a-b, the FBG zone 16 includes an array of periodical high-low refractive index grids. The spacing of the grid corresponds to an integer multiple of the half-wavelength of a designated light wavelength. When the broadband light beam 24 enters one end of the FBG zone 16 the portion of the light beam 24 with the designated wavelength is reflected as a reflected beam 24a and the other light wavelengths present are transmitted through the FBG zone 16 as a passed beam 24b. This phenomenon is symmetric, i.e., it is the same regardless of the entering direction of the light beam 24, and it is called the “Bragg condition.” It is expressed as λ=2d/n, where λ is the designated wavelength, d is the grid spacing, and n is the refractive index.

With reference again primarily to FIG. 3, when a train passes by the position of an FBG unit 14 installed in the tracks 12, the physical shape of the railway track 12 is temporarily distorted (slightly) by the weight of the train. This physical distortion causes the grid spacing of the FBG zone 16 to change temporarily as well, resulting in a corresponding shift of the wavelength in the reflected beam 24a. Furthermore, this wavelength shift effect is proportional to the weight of the passing train.

Since the optical signals (light beams 24, 24a, 24b) can all be transmitted very long distances through the optical fiber 18 without losing the finesse of the signal-to-noise ratio, there is no need for electricity at the location or locations where the FBG units 14 are installed. The light source 22, a receiver 26 for detecting the reflected beam 24a, and a microprocessor 28 can all therefore be placed some distance away from the FBG units 14.

In FIG. 3 a sophisticated control system 30 includes the light source 22 (a laser), two receivers 26, the microprocessor 28, a data acquisition module 32, and a telecommunications module 34. The FBG units 14 are configured as two serially connected sets of three, one set per track 12. [Of course, parallel connection arrangements of the FBG units 14 with optical fiber 18 are also possible.] This produces two reflected beams 24a, one per receiver 26. Since there are three FBG units 14 per channel here, each reflected beam 24a arriving back at a receiver 26 can potentially have up to three distinct light wavelengths. By detecting these with the receivers 26 and the data acquisition module 32, the microprocessor 28 can process in real time and employ the telecommunications module 34 to communicate with one or more external systems 36.

The external systems 36 can include, without limitation, traditional Red/Green railway warning lights, railway station control room systems, and public safety systems. For instance, since the inventive fiber optic track circuit 10 can be used to determine both the weight and the speed of a passing train, it can easily be configured to automatically provide a warning to train engineers, railway station personnel, and civil authorities. Unlike prior art systems, however, the warnings from the inventive fiber optic track circuit 10 can be much more informative. For instance, they can report if a train is moving too fast, is too heavy, or if train is detected with a particular combination of both speed and weight that is hazardous.

Traditional, electric track circuits are particularly subject to damage by a powerful force of nature, lightning. The inherent conductive nature of railway rails and the typically long paths that electrical wiring to and from track switches must travel puts conventional electrical track circuits and their control systems at great risk. A lightning strike some distance up or down a railway line can thus disable a track circuit. Lightning strikes anywhere along the electrical wiring path can also induce electrical noise into the system that triggers false reports or even burns out track circuit or control system components. The inventive fiber optic track circuit 10 is not at risk from lightning, unless it strikes so directly and powerfully that heat or explosive force physically damages the fiber optic track circuit 10. Similarly, the fiber optic track circuit 10 does not but its control system 30 or other systems at risk because its substantial elements are not conductive and thus cannot convey electricity to where it can cause damage.

In summary, the fiber optic track circuit 10 provides considerable benefits. No electricity is required at the actual installation site. There accordingly is no need for a battery at such sites, and no (electrical) isolation between sections of track 12 are needed at such site. This not only saves on direct installation costs, it also reduces the installation and maintenance times needed, thus allowing more frequent scheduling of trains on the effected lines. There is also no signal-to-noise degradation during bad weather, from snow, rain, or salt, etc., and there is no concern about shorting the circuit during railway track maintenance, system calibration, or any accident creating an electrically conductive path between the railway tracks.

The fiber optic track circuit 10 is accurate and reliable. It can easily be set to not produce false alarms, since it will respond only to the presence of the appreciable weight of a passing train. The fiber optic track circuit 10 is also durable. Fiber optic type sensors in other applications are known for their long operating life time, unless they are purposely damaged by humans or natural disasters.

The fiber optic track circuit 10 can also easily provide directionality, speed determination, and acceleration measurement. With two units, determining direction can be as simple as seeing which fiber optic track circuit 10 is actuated first. Since the position of each fiber optic track circuit 10 is fixed, measuring the amount of time for a train to travel from one to the other permits speed calculation. Further, if three or more fiber optic track circuits 10 are mounted at known positions, the acceleration of a train can also be calculated. All of this additional information is often important information, since it can permit railway personnel and other appropriate authorities to insure more efficient and safe railroad operations.

With its weight detection capability, the fiber optic track circuit 10 can measure the weight of a passing train. This in combination with directionality, speed, and acceleration provides even more potential benefit. For example, to infer whether a particular train is a passenger or freight train, and to ensure that weight limits, weight and speed limits, or weight and acceleration limits are not exceeded. This also can be important information for railway and local emergency personnel.

In addition, the fiber optic track circuit 10 permits much more information to be integrated. For example, it permits improved collision avoidance. Since all of the speed, weight, direction, etc., of all of the trains on the various track sections can now be better identified and monitored, the probability of train collisions can be greatly reduced.

FBG's are sensitive to temperature, but this can be used intentionally and quite beneficially by the inventive fiber optic track circuit 10. By letting temperature affect the FBG units 14, railway personnel can be informed in real time if an installed location has an abrupt temperature change or is experiencing an extreme temperature. In some locations in the world such a change can be indicative of flood waters crossing or ice freezing over tracks, potentially presenting a sever hazard to trains. In general, abnormally low or abnormally high temperatures are also a serious cause of derailments. Temperatures in some places, such as desert regions, can range daily by as much as 75° F. (25° C.). Large numbers of such cycles can cause tracks to work loose from ties and for other railway structure to subtly degrade. The fiber optic track circuit 10 permits aggregating data about this and employing it to improve railway safety and to conduct preemptive inspection and maintenance in ways not previously practical.

Alternately, if FBG sensitivity to temperature is a disadvantage in a particular application, it can be compensated for. The FBG units 14 that are used can be an athermal type (such as the fiber optic sensor offered by Fibera, Inc. of Santa Clara, Calif.), or the control system 30 can measure ambient temperature and adjust the data it works with as needed. Or both stressed and un-stressed FBG units 14 can be employed (literally alongside one another if desired). The reflected beam 24a of a stressed FBG unit 14 (i.e., one stressed train weight or some other direct physical influence) can then be differentially processed with the reflected beam 24a from a non-stressed FBG unit 14 (i.e., one stressed only by indirect physical influences, like ambient temperature). Still better, both athermal and normal FBG units 14 can be employed together at the same location, to provide yet more information.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A fiber optic track circuit, comprising:
a light source, a first fiber Bragg grating (FBG) unit, and a first receiver all connected by optical fiber;
said light source to provide a light beam and said optical fiber to convey said light beam to first FBG unit;
said first FBG unit being mountable on a first portion of a railway system directly effected by the weight of a passing train;
said first FBG unit to receive said light beam and to provide a first reflected beam to said first receiver;
said first receiver to provide a first receiver signal based on said first reflected beam; and
a processor to determine based on pre-set criteria and said first receiver signal whether to communicate and what to communicate as a track circuit signal to an external device.

2. The track circuit of claim 1, wherein said light beam includes light of a resonant wavelength of said first FBG unit in a normal unstressed state.

3. The track circuit of claim 2, wherein said light beam includes light having a range of wavelengths including said resonant wavelength of said first FBG unit.

4. The track circuit of claim 1, further comprising:
a second FBG unit and a second receiver also connected by said optical fiber;
said optical fiber to also convey said light beam to said second FBG unit;
said second FBG unit being mountable on a second portion of said railway system that is also directly effected by the weight of said passing train;
said second FBG unit to receive said light beam and to provide a second reflected beam to said second receiver;
said second receiver to provide a second receiver signal based on said second reflected beam; and
said processor to additionally determine at least one member of the set consisting of direction of movement and speed of movement of said passing train based on said first receiver signal and said second receiver signal.

5. The track circuit of claim 4 further comprising:
a third FBG unit and a third receiver also connected by said optical fiber;
said optical fiber to also convey said light beam to said third FBG unit;
said third FBG unit being mountable on a third portion of said railway system that is also directly effected by the weight of said passing train;
said third FBG unit to receive said light beam and to provide a third reflected beam to said third receiver;
said third receiver to provide a third receiver signal based on said third reflected beam; and
said processor to additionally determine acceleration of said passing train based on said first receiver signal, said second receiver signal, and said third receiver signal.

6. The track circuit of claim 1, further comprising:
a second FBG unit and a second receiver also connected by said optical fiber;
said optical fiber to also convey said light beam to said second FBG unit;
said second FBG unit being mountable where it is not effected by the weight of said passing train;
said second FBG unit to receive said light beam and to provide a second reflected beam to said second receiver;
said second receiver to provide a second receiver signal based on said second reflected beam; and
said processor to differentially normalize said first receiver signal based said second receiver signal.

7. A process for determining information about a train passing through a railway system, the process comprising:
conveying a light beam to a first fiber Bragg grating (FBG) unit mounted on a first portion of the railway system that is directly effected by the weight of the passing train;
producing a first reflected beam at said first FBG unit based on said light beam;
conveying said first reflected beam to a first receiver;
producing a first receiver signal at said first receiver based on said first reflected beam; and
processing said first receiver signal based on pre-set criteria to obtain the information.

8. The process of claim 7, wherein said light beam includes light of a resonant wavelength of said first FBG unit in a normal unstressed state.

9. The process of claim 8, wherein said light beam includes light having a range of wavelengths including said resonant wavelength of said first FBG unit.

10. The process of claim 7, further comprising:
conveying said light beam to a second FBG unit mounted on a second portion of the railway system that is also directly effected by the weight of the passing train;
producing a second reflected beam at said second FBG unit based on said light beam;
conveying said second reflected beam to a second receiver;
producing a second receiver signal at said second receiver based on second first reflected beam; and
processing said first receiver signal and said second receiver signal to include at least one member of the set consisting of direction of movement and speed of movement of said passing train in the information.

11. The process of claim 10, further comprising:
conveying said light beam to a third FBG unit mounted on a third portion of the railway system that is also directly effected by the weight of the passing train;
producing a third reflected beam at said third FBG unit based on said light beam;
conveying said third reflected beam to a third receiver;
producing a third receiver signal at said third receiver based on said third reflected beam; and
processing said first receiver signal, said second receiver signal, and said third receiver signal to include acceleration of the passing train in the information.

12. The process of claim 7, further comprising:
conveying said light beam to a second FBG unit mounted where it is not effected by the weight of the passing train;
producing a second reflected beam at said second FBG unit based on said light beam;
conveying said second reflected beam to a second receiver;
producing a second receiver signal at said second receiver based on second first reflected beam; and
differentially normalizing said first receiver signal based on said second receiver signal.

13. The process of claim 7, further comprising communicating the information to a location remote from that of the rest of the process.

14. A system for determining information about a train passing through a railway system, comprising:
first Bragg means for reflecting a first particular light wavelength based on the Bragg effect, wherein said first Bragg means is mountable on a first portion of the railway system that is directly effected by the weight of the passing train;
first producing means for producing a first receiver signal based on said first particular light wavelength;
means for processing said first receiver signal based on pre-set criteria to obtain the information; and
means for conveying a light beam to said first Bragg means, for conveying said first particular light wavelength to said first producing means, and for conveying said first receiver signal to said means for processing.

15. The system of claim 14, further comprising:
second Bragg means for reflecting a second particular light wavelength based on the Bragg effect, wherein said second Bragg means is mountable on a second portion of the railway system that is also directly effected by the weight of the passing train;
second producing means for producing a second receiver signal based on said second particular light wavelength; and wherein
said means for conveying further is for conveying said light beam to said second Bragg means, for conveying said second particular light wavelength to said second producing means, and for conveying said second receiver signal to said means for processing; and
said means for processing is further for processing said first receiver signal and said second receiver signal to include at least one member of the set consisting of direction of movement and speed of movement of said passing train in the information.

16. The system of claim 15, further comprising:
third Bragg means for reflecting a third particular light wavelength based on the Bragg effect, wherein said third Bragg means is mountable on a third portion of the railway system that is also directly effected by the weight of the passing train;
third producing means for producing a third receiver signal based on said third particular light wavelength; and wherein
said means for conveying is further for conveying said light beam to said third Bragg means, for conveying said third particular light wavelength to said third producing means, and for conveying said third receiver signal to said means for processing; and
said means for processing is further for processing said first receiver signal, said second receiver signal, and said third receiver signal to include acceleration of the passing train in the information.

17. The system of claim 14, further comprising:
second Bragg means for reflecting a second particular light wavelength based on the Bragg effect, wherein said second Bragg means is mountable where it is not effected by the weight of the passing train;
second producing means for producing a second receiver signal based on said second particular light wavelength; and wherein
said means for conveying further is for conveying said light beam to said second Bragg means, for conveying said second particular light wavelength to said second producing means, and for conveying said second receiver signal to said means for processing; and
said means for processing is further for processing to differentially normalize said first receiver signal based said second receiver signal.

18. The system of claim 14, further comprising means for communicating the information to a location remote from the system.
